(19) United States
(12) Patent Application Publication
(10) Pub. No.: US 2013/0279097 A1
(43) Pub. Date: Oct. 24, 2013

(54) Substantially Concealed Smart Housing For Wall Mounted Electrical Elements

(71) Applicant: Haim Jacobi, Tel Aviv (IL)

(72) Inventor: Haim Jacobi, Tel Aviv (IL)

(21) Appl. No.: 13/979,185

(22) PCT Filed: Feb. 24, 2011
(86) PCT No.: PCT/IL11/00190

§ 371 Date: Jul. 11, 2013

(30) Foreign Application Priority Data
Jan. 13, 2011 (IL) 210651

(51) Int. Cl. H02B 1/40

(52) U.S. Cl. CPC H02B 1/40
USPC 361/679.01

(57) ABSTRACT

The present invention is generally directed to an enclosure box or housing for wall mounted electrical element(s) which is provided with an automatic power door. The present invention provides a smart automatic and autonomous housing for wall mounted electrical elements which minimises the user's effort and maximizes the time the electrical element is concealed. The said functionality is achieved by providing a housing comprising one or more sensors, a motor and a door that can switch between open/closed positions automatically. Moreover, the present invention provides the housing with a capability to perform certain tasks related to the operations or status of the electrical element also when the door is in a closed position.

### FIELD OF THE INVENTION

The present invention relates to the field of wall mounted electrical elements. More particularly, the invention relates to a smart autonomous housing for wall mounted electrical elements, such as numerous types of outlets (e.g., electrical, RJ45, phone, TV, etc.), controllers (e.g., lights, curtains, HVAC, etc.), switches and other common control elements which will look like a part of that wall surface when not in use, by automatically concealing any operational parts of the electrical element and leaving only a visible contour on the wall surface.

### BACKGROUND OF THE INVENTION

The existence of wall mounted electrical elements in homes today comes out of a necessity, or a need, and not out of a choice. Many appliances require these electrical elements as a power source (e.g., electrical outlet) or control unit (e.g., light switch or HVAC controller). Oftentimes those electrical elements are not in use (i.e., not connected to any device, in the case of a plug, or only used infrequently to increase the room temperature, in the case of an HVAC controller, etc). Conventional wall mounted electrical elements, such as outlets, switches and the like, usually have an accommodating box or housing which contains one or more of such electrical elements. Such housings usually have a traditional faceplate which leaves the operational part of the electrical element revealed. However, this conventional arrangement (i.e., the housing and its corresponding faceplate) detracts from the appearance of the wall. The result is a wall surface with visible electrical elements and faceplates which damage the continuous and clean appearance of the wall's surface. Moreover, such conventional arrangements are usually exposed and therefore might not be safe for children who can insert metal objects into the live terminals of the receptacle. This exposure furthermore allows unauthorized persons to touch switches or other controllers, which might be unwanted by the proprietor.

Certain newer prior art wall mounted electrical elements try to be more appealing by applying design, illumination, or colors. Other applications aim to achieve minimum visibility by concealing, as much as possible, the electrical element and its visible contours. WO 2008/033181, commercially known, as “Trufig”, discloses a method for flush mounting an electrical element. However, the operational parts of the outlet are still exposed and can easily be seen. The result is a non-plain wall surface with visible switches or receptacles/outlets.

Another product commonly known in the art as the “Concealite”, or the “Concealite Discover Series” (hereinafter, “Concealite”) is described under the following URL address: http://wwww.concealite.com/discover_series.html. The Concealite device essentially is a housing for outlets which allows receptacles/outlets to be concealed in a standard piaster wall behind a manual rotating door and is finished (e.g., by paint) to approximate or to relatively match the interior wall color, texture or finish when the door is in the closed position. The term “plaster wall” herein refers to any commonly known type of plaster wall, drywall, or gypsum wall.

Such prior art devices have several drawbacks. A first drawback arises from the discrepancy between keeping the wall mounted electrical element concealed, and at the same time user-friendly. Those elements are in many cases used frequently, which means that minimising the user's effort is of high relevance. Unfortunately, such a manual rotating door as referred to above usually causes extra efforts each time someone wants to use the electrical element. For example, using an electrical outlet will require three steps instead of one: 1) opening the door; 2) using the electrical outlet; and 3) closing the door. The result might be that a person prefers to leave the rotating door open or altogether avoids installing the product, as using it is more complicated than resorting to conventional arrangements where the operational part of the electrical element is revealed.

A second drawback emerges from the difficulty to identify the electrical element when it is concealed. When the door is in a closed position, different types of wall mounted electrical elements (e.g., light switch, electrical outlet, and RJ45 outlet, etc.) look the same, making it cumbersome for the user to both locate them on the wall and identity their type. To address these problems and to provide a flush and esthetic solution for wall mounted electrical elements, an enhanced housing is required.

It is an object of the present invention to provide a wall mounted arrangement which will not detract from the appearance of a wall or will not damage the wall's exterior appearance.

It is another object of the present invention to provide an autonomous housing for wall mounted electrical elements which will look like a part of the wall when not in use by automatically concealing any operational parts of the outlet and leaving only a visible contour on the wall surface.

It is another object of the present invention to maximize the time the housing is in a closed position, concealing the wall mounted electrical elements.

It is another object of the present invention to provide a way to easily identify, locate and operate the wall mounted electrical elements when the housing is in a closed position.

It is another object of the present invention to provide a safe and secure arrangement for wall mounted electrical elements.

Other objects and advantages of the invention, will become apparent as the description proceeds.

### SUMMARY OF THE INVENTION

The present invention is generally directed to an enclosure box or housing for wall mounted electrical element(s) which is provided with an automatic power door. The present invention provides a smart automatic and autonomous housing for wall mounted electrical elements which minimizes the user's effort and maximizes the time the electrical element is concealed. The said functionality is achieved by providing a housing comprising one or more sensors, a motor and a door that can switch between open/closed positions automatically. Moreover, the present invention provides the housing with a capability to perform certain tasks related to the operations or status of the electrical element also when the door is in a closed position.

The door and the housing are flush mounted on the wall thereby providing an esthetic solution for wall mounted electrical elements. The housing's door can he opened by input signals received from at least one of the sensors which enable the detection of a person's intention to use the electrical element. Optionally, gestures detection may signal the electric motor to move the door to an open position only when a specific combination is detected, very similar to a security code. In this manner, an enhanced safety and secure mechanism can be achieved.

Additionally, gesture detection according to pre-defined gesture combinations may actuate the electrical element concealed behind the door. This can eliminate the need to open the door for certain frequent operations. This feature of the housing of the present invention further maximizes the time the electrical element remains concealed.

The housing of the present invention operates completely autonomously by receiving all inputs and commands from inbuilt components, such as sensors, a control circuit, etc.

The present invention relates to a substantially concealed smart housing for wall mounted electrical elements, wherein said housing is configured to be installed in a flush manner in a wall, said housing comprises: a) at least one electrical element; b) a door for allowing on demand access to said at least one electrical element, wherein said housing is configured in such a way that whenever said door is completely closed, only a contour around said door is visible on the wall in which said housing is installed; c) an electric motor mechanically connected to said door, for moving said door between closed and open positions: d) a control circuit for performing tasks related to the determination whether to open or close said door automatically or for performing tasks related to the status of said at least one electrical element, wherein said control circuit is electrically connected to said motor; e) one or more sensors, electrically connected to said control circuit, for providing information to said control circuit in order to trigger said control circuit to perform said tasks, wherein said sensor(s) is positioned in said housing in such a way that said sensor(s) is used at least for detecting the intention to use said electrical element(s) and for detecting whenever said electrical element(s) is in use; and f) a power supply source for feeding the electrical components of said housing.

According to an embodiment of the present invention, the sensors are selected from the group consisting of: proximity, touch, sound, light, movement, micro-switch, or combination thereof.

According to an embodiment of the present invention, the control circuit comprises a memory module for storing pre-defined information related to the operation of the door and/or information related to the operating or status of at least one of the electrical elements. The pre-defined information may represent a combination of one or more gestures detected by at least one sensor. The pre-defined information can he programmable or preprogrammed.

According to an embodiment of the present invention, the control circuit is further used in combination with at least one of the sensors for obtaining a correct sequence which represents the stored pre-defined information, wherein the correct sequence is a time based sequence and/or gesture based sequence.

According to an embodiment of the present invention, the smart housing further comprises one or more light sources, wherein said light sources emit one or more light colors, either automatically and/or according to one or more gestures. In some embodiments, at least one of the light sources can be used to provide visual information regarding the status of the electrical element, whenever said electrical element is electrically connected to the control circuit. Additionally, at least one of the light sources can be used to provide visual information regarding the type of the concealed electrical element.

According to an embodiment of the present invention, the electrical element(s) can be attached to the smart housing via corresponding socket(s), wherein said sockets can he used to detach or replace said electrical element(s).

According to some embodiments of the present invention, whenever the door is completely open, it is fully contained in said housing in such a way that said door is minimally visible.

According to an embodiment of the present invention, the control circuit may control the door as follows:
instructs the door to remain open whenever at least one of the sensors detects that the electrical element(s) is in use;
instructs the door to move into a closed position whenever the electrical element(s) is not in use; and
instructs the door to move into an open position whenever at least one of the sensors detects: the intention to use the electrical element(s).

According to an embodiment of the present invention, the control circuit is electrically connected to at least one of the electrical elements in order to operate said electrical element(s) and/or to receive information related to the electrical element(s), thereby the control circuit can operate the electrical element whenever at least one of the sensors detects the intention to use the electrical element(s).

The present invention further relates to a method for allowing to operate and conceal, automatically and autonomously, at least one wall mounted electrical element which is located within a smart housing, wherein said housing is mounted in a flush manner on a wall while said electrical element is substantially concealed behind a door of said housing thus whenever said door is closed, only a contour around said door is visible on the wall in which said housing is installed, said method comprises the steps of: a) normally keeping said door in a closed position until receiving a first signal(s) for opening said door, wherein said first signal is generated by a control circuit according to information received from at least one sensor and/or pre-defined definitions; b) whenever receiving said first signal automatically moving said door to an open position, thereby allowing access to said electrical element until receiving a second, signal(s) for closing said door, wherein said second signal is generated by said control circuit according to information received from at least one sensor and/or pre-defined definitions; and c) whenever receiving said second signal automatically moving said door to the closed position, wherein automatically moving said door between closed and open positions is done by an electric motor.

According to an embodiment of the present invention the pre-defined definitions are selected from the group consisting of: time interval(s), one or more gestures, sensor output data, or any combinations thereof. According to some embodiment of the present invention the method further comprises operating the electrical element by directly using one or more of the pre-defined definitions, thereby eliminating the need to open the door.

### BRIEF DESCRIPTION OF THE DRAWINGS

In the drawings:

FIGS. 1A and 1B schematically illustrate a substantially concealed smart housing for wall mounted electrical elements, according to an embodiment of the present invention;

FIGS. 2A to 2J schematically illustrate the smart housing provided with a variety of electrical elements, according to some embodiments of the present invention;

FIGS. 3A and 3B schematically illustrate in a cross-sectional view a technique to operate the door of the smart housing, according to an embodiment of the present invention;

FIGS. 3C and 3D schematically illustrate in a cross-sectional view a technique to operate the door of the smart housing, according to another embodiment of the present invention;

FIG. 3E schematically illustrates in a cross-sectional view a technique to operate the door of the smart housing, according to another embodiment of the present invention; and

FIGS. 4A-4F and FIGS. 5A-5E schematically illustrate basic installations for attaching the smart housing to walls, according to some embodiment of the present invention.

### DETAILED DESCRIPTION OF THE EMBODIMENTS

The term “home” herein refers to any structure in which one or more wall mounted electrical elements: are located, such as a residence home, hotel, office, factory, etc.

The terms “wall mounted electrical element” or “electrical element” when referred to herein relate to various types of outlets (electrical, RJ45, phone, TV, etc), controllers (alarm keypad, curtain controller, HVAC controller, etc.), switches (e.g., light switch) and other common control elements (e.g., touch screens) which are wall mounted. It should be noted that the housing suggested by the present invention is used for wall mounted electrical elements which require physical or manual human involvement, e.g., touching a button, or inserting a plug.

The terms “flush” or “flush manner” refer herein to the installation of the housing in such, a way that the doer side of the housing will look like an integral part of the wall.

The term “gesture” refers herein to any operation performed by a user, such as body movement, touching, sound (e.g., voice), etc.

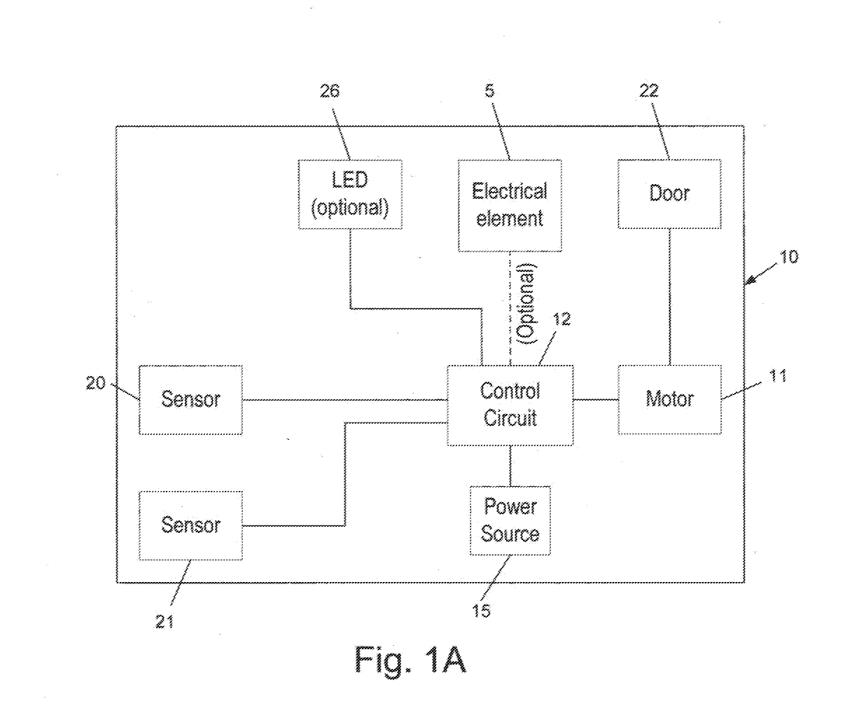

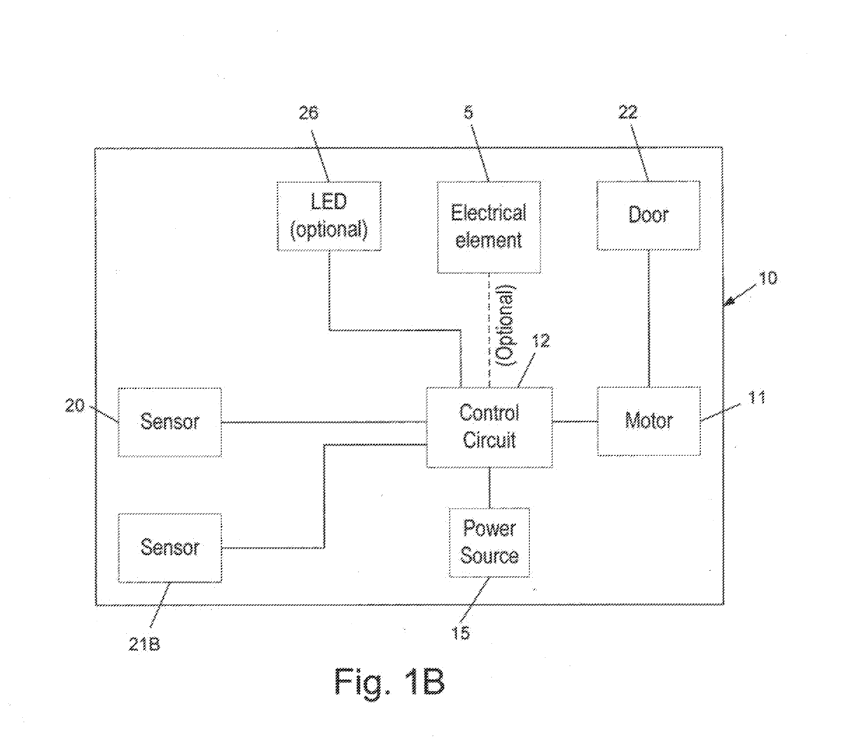

FIG. 1A schematically illustrates a block diagram form of a substantially concealed smart housing 10 for wall mounted electrical elements, according to an embodiment of the present invention. Housing 10 comprises an electric motor 11 (e.g., a common step-motor, magnetic motor triggered by electric power, etc.). a control circuit 12, one or more electrical elements 5, a door 22, one or more sensors (such as sensor 20 and/or sensor 21) and a power supply source 15 (such as a transformer being fed from the main power line or a battery) for feeding the electronic components, such as the electric motor 11, the control circuit 12, the sensors 20 and 21, etc. Additionally, the housing 10 may further comprise a light source, such as LED 36.

According to an embodiment of the present invention, housing 10 is attached to a wall in such a way that when door 22 is in a closed position, from a perpendicular view of the wall, housing 10 will look like a part of that wall concealing any operational parts of the electrical element located within housing 10 and leaving only a visible contour on the wall surface (the outline(s) of the visible contour corresponds to the shape of the door(s) of housing 19), by being substantially flush and finished to approximate or relatively match the wall color and texture. For an even more aesthetic appearance, when door 22 is in an open position, from a perpendicular view of the wall door 22 can be fully contained within housing 10 in such a way that door 22 is minimally visible.

Control circuit 12 is used to decide when door 22, one or more electrical elements 5, and, optionally, the LED 26 are actuated. The control circuit 12 acts according to input signals provided from at least one of the following elements: one or more of the sensors (e.g., sensors 20 and/or 21), electrical element(s) 5 or any combination thereof. For example, control circuit 12 can be any suitable controller, micro-controller, PCB, ASIC or other programmable control units.

According to some embodiments of the present invention, control circuit 12 may also be used for determining the time elapsed. For example, control circuit 12 will count a pre-defined number of seconds starting at the moment door 22 moves to an open position. At the end of that counting, control circuit 12 instructs the motor 11 to move door 22 to a closed position. This way, the door is closed automatically after having given the user sufficient time to perform one or more tasks related to the electrical element 5. Housing 10 may comprise several types of sensors for allowing the operation of the door and/or at least one of the electrical elements installed, within said housing by performing at least the following two types of detection operations:
detecting whenever the electrical element 5 is in use white the door 22 is in an open position. For example, when a plug is connected to an outlet or when a person, is using an alarm keypad. This can he used to keep the door 22 open as long as the electrical element is in use. In such cases, the operation mode can be as follows: sensor 20 detects the presence of an object (e.g., the plug or the user's hand) and accordingly generates a corresponding signal(s) to the control circuit 12. As a result of such signal(s), the control circuit 12 instructs the motor 11 to keep door 22 in an open position; and
detecting a person's intention to use the electrical element while the door 22 is in a closed position. This may actuate the operation of the door 22 and/or at least one electrical element 5 installed within housing 10 according to some pre-defined information (as will be described in further details hereinafter).

According to some embodiments of the invention, the pre-defined information can he stored in a memory module (not shown) associated with control circuit 12 and may represent gesture combinations as well as the associated operation of the door 22 and/or at least one electrical element 5.

Any combination of gestures detectable fey the sensor(s) is possible (e.g., waving the hand a certain number of times and/or one or more taps on the door 22). A combination may further include a correct sequence based on time elapsed and/or gestures (e.g., two taps on the door 22, 1 second pause, and another tap).

According to some embodiments of the present invention, detecting a person's intention to use the electrical element can actuate the door 22. For example, a touch sensor 21 (e.g., a piezoelectric sensor) which by exerting touching pressure against the door will actuate the electric motor to move the door to its open position. In that case, sensor 21 can be located on the internal side of door 22, in order to provide a better response while a user touches door 22.

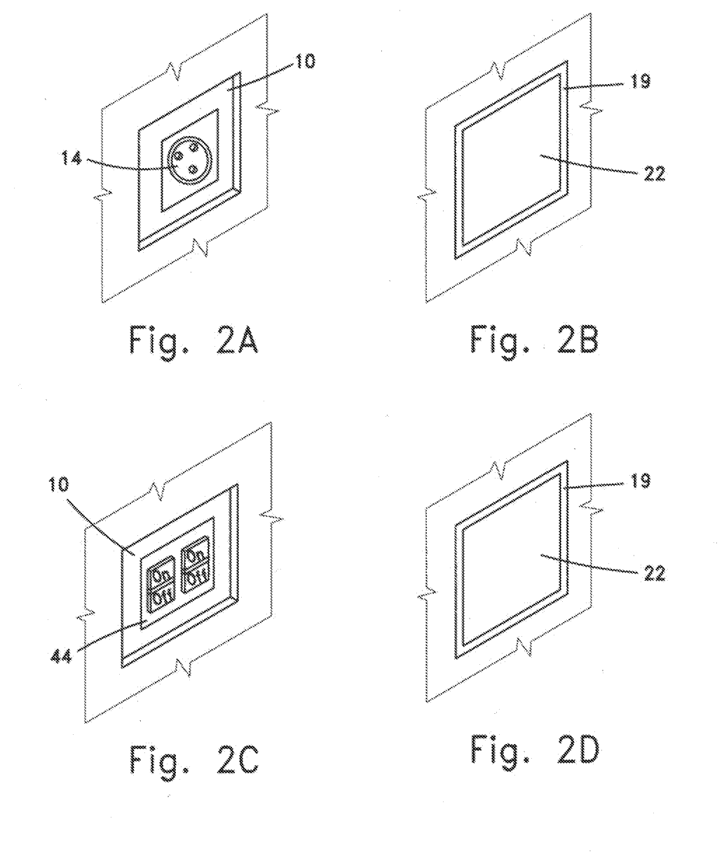

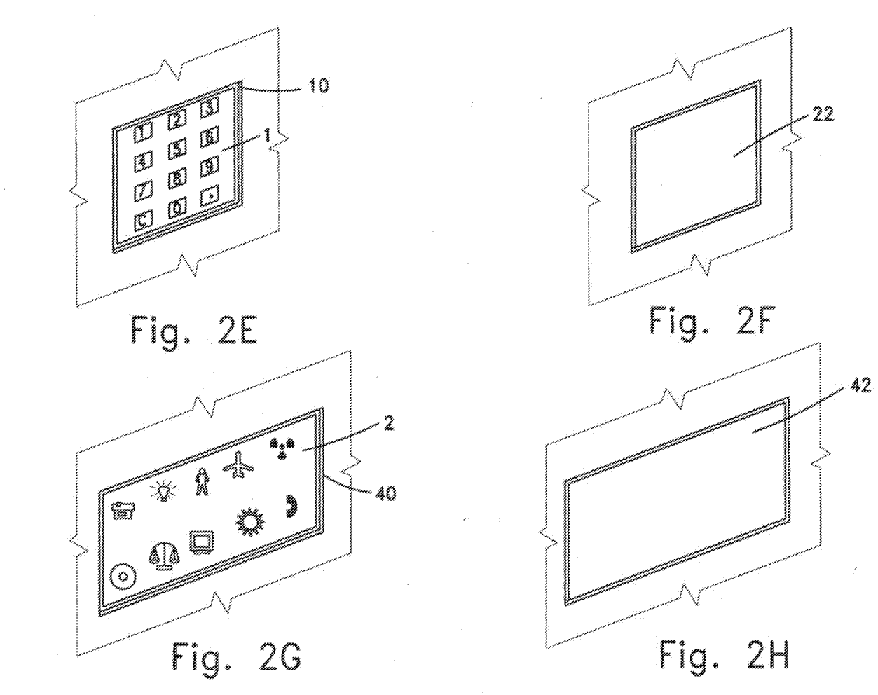

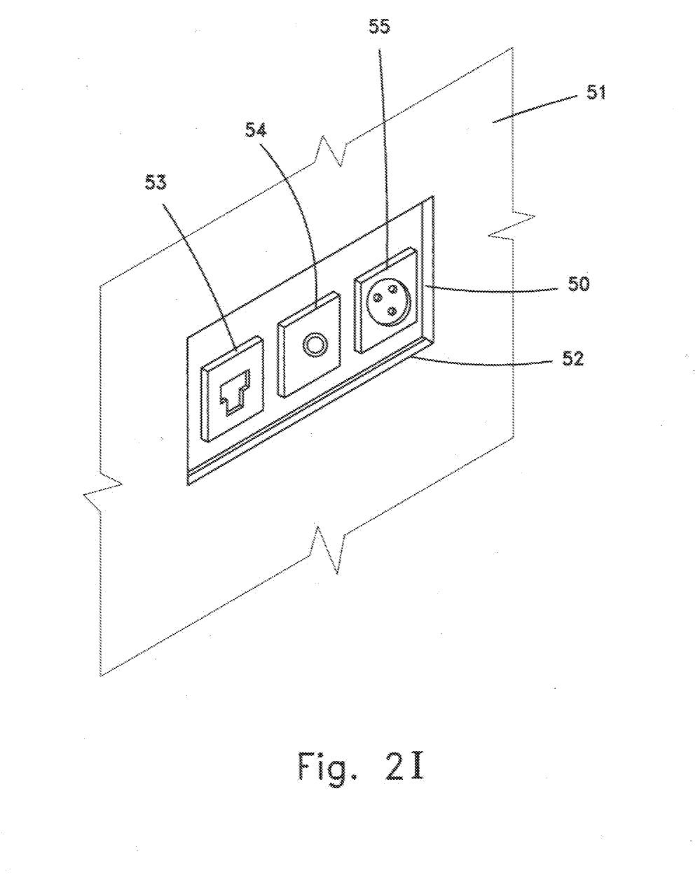

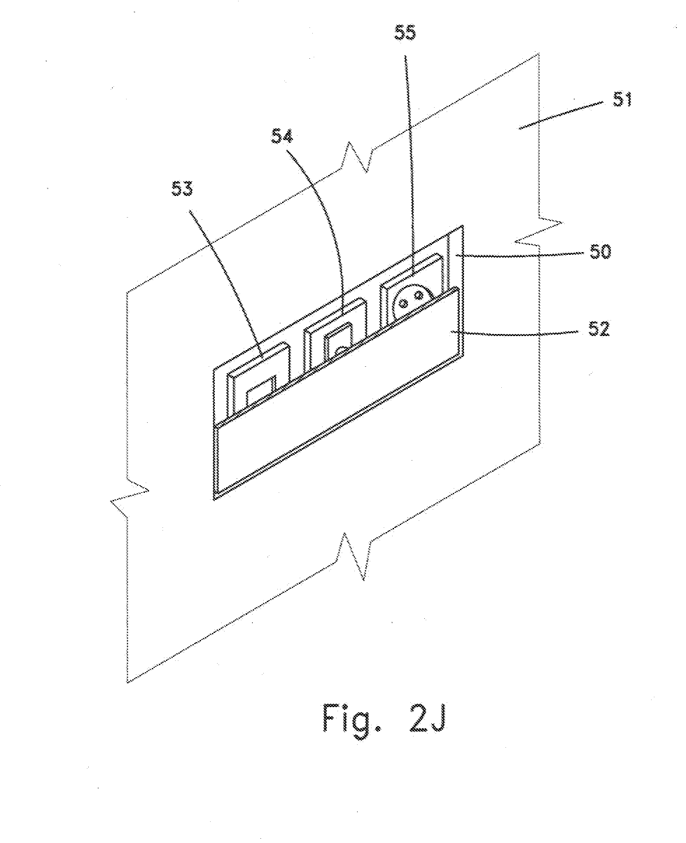

Another example would he to employ a proximity sensor 21B (FIG. 1B) which by sensing whenever an object (e.g., a plug, a user's hand, etc.) is approaching door 22 of housing 10 will actuate the electric motor 11 to move the door 22 to its open position. A proximity sensor is a sensor able to detect the presence of nearby objects without any physical contact. For example, the proximity sensor can he a common sensor which emits an electromagnetic or electrostatic field, or a beam of electromagnetic radiation (infrared, for instance), and looks for changes in the field or return signal. In that case, sensor 21B can he located in such a way that it will be able to sense a moving or approaching object via the visible contour (i.e., an exposed niche) surrounding door 22 whenever door 22 is in a closed position (for example, such an exposed niche is indicated by numeral 19 in FIGS. 2B, 2D).

According to some embodiments of the present invention, door 22 can only be actuated if certain pre-defined gestures are detected, similarly to a security code. In this manner, the electrical element 5 will be concealed from and unreachable to unauthorized persons (e.g., children).

According to some embodiments of the present invention, detecting a person's intention to use the electrical element can actuate key operations (e.g., most common tasks) of the electrical element 5 concealed behind the door 22 without the need to open door 22 by detection of pre-defined gesture combinations. For example, one touch or hand wave can actuate a multi-light switch within the housing in order to turn on the main lights.

The sensors, such as sensor 20 or 21 may he proximity, touch, pressure, movement, sound sensors, etc. It should be noted that the sensors' functionalities of detecting whenever the electrical element(s) is in use and of detecting the intention to use said electrical element(s) 5 may be obtained by the same component (i.e., by the same sensing unit).

As mentioned hereinbefore, housing 10 may farther comprise one or more light sources, such as LED 28. According to some embodiments of the present invention, a plurality of light colors may be combined in order to provide different indicative information. Preferably, the lighting source is positioned in such a way that the wavelengths emitted by it will pass through the exposed niche surrounding door 22 (for example, such a niche is indicated by numeral 19 in FIGS. 2B and 2D) thereby allowing a user to see the emitted light when the door 22 is in a closed position. The light source (s) can be used for several purposes:
Since wall mounted electrical elements according to the present invention are minimally visible when door 22 is in a closed position, LED 26 can be used to emit light in order to allow lasers to identify the location of a switch (e.g., for turning on the lights) in a dark area or room,
LED 26 can be used to indicate the status of an electrical element located within housing 10 (e.g., whether the boiler or some switch is turned on, the status of an alarm system, etc.), this eliminates the need to open door 22 and further maximizes the time the electrical element remains concealed.
Whenever the door 22 is in a closed position, different types of electrical elements may look the same (as seen in FIGS. 2B and 2D). Therefore, LED 26 can he used to identify the type of the electrical element installed within housing 10 (e.g., red light for outlet, white light for switch).

According to some embodiments of the present invention, the electrical elements 5 are attached to housing 10 via a corresponding socket or sockets. The socket can be used to attach/detach an electrical element or replace an existing one in a plug-and-play manner. For example, this can be done by connecting the electric network wiring to the socket, while the socket itself includes connectors which electrically connect the electric element attached to it.

FIGS. 2A to 2F schematically illustrate the smart housing 10 installed in the wall (substantially in a flush manner) and provided with a variety of electrical elements, according to some embodiments of the present invention. For example, FIG. 2A shows the housing 10 in an open position (i.e., door 22 is completely open) thereby revealing the electrical element installed within it. In this embodiment, the electrical element is an electrical outlet 14. The corresponding FIG. 2B shows housing 10 in a closed position (i.e., door 22 is completely closed).

FIGS. 2C and 2D show the housing 10 in open and closed positions. Thus, when door 22 is completely open, the electrical element installed within it is revealed. In this embodiment, the electrical element is a double light switch 44. FIG. 2D shows housing 10 in a closed position (i.e., door 22 is completely closed).

FIGS. 2E and 2F show the housing 10 in open and closed positions. Thus, when door 22 is completely open, the electrical element installed within it is revealed. In this embodiment, the electrical element is an alarm touchpad 1.

FIG. 2F shows housing 10 in a closed position (i.e., door 22 is completely closed).

FIGS. 2G and 2H show a housing 40 in open and closed positions. Thus, when the door 42 is completely open, the electrical element installed within it is revealed. In this embodiment, the electrical element is a home automation touch screen controller 2. FIG. 2H shows housing 40 in a closed position (i.e., door 42 is completely closed).

FIGS. 2I and 2J show a housing 50 in open and closed positions installed in wall 51. according to an embodiment of the present invention. Thus, when a door 52 is completely open, the electrical elements installed within it are revealed. In this embodiment, the electrical elements are an RJ45 outlet 53, an AV outlet 54, and an electrical outlet 55. FIG. 2J shows housing 50 with door 52 in a closed position. For illustrative purposes only, door 52 is illustrated in this figure as partially cut, in order to schematically show the installed electrical element while the door 52 is closed.

Hereinafter, some of the operations, advantages and optional implementations of the housing of the present invention will be demonstrated by way of example.

### EXAMPLE 1

Referring now to FIGS. 2A and 2B, the wall mounted electrical element is an electrical outlet 14. Control circuit 12 (FIG. 1A) is programmed to open door 22 only when a triple-tap combination is detected by sensor 21 (FIG. 1A) as a child safety measure (i.e., a child will not be able to accidentally open door 22 and insert metal objects into the live terminals of the receptacle). Once door 22 is open, when a cable is plugged into outlet 14, it is detected by sensor 20 (FIG. 1A), and accordingly door 22 remains open.

### EXAMPLE 2

Referring now to FIGS. 2B and 2F, the wall mounted electrical element is an alarm touchpad 1. Door 22 will only he opened when sensor 21B (FIG. 1B) is a proximity sensor which detects for example the following combination: holding the hand for 2 seconds in front of door 22, removing it, wait 3-4 seconds, and then holding it again in front of door 22 for 2 seconds. Therefore, the alarm touchpad 1 is invisible behind door 22 which will not be opened without the right combination, providing an enhanced protection from unauthorized persons.

### EXAMPLE 3

Referring now to FIGS. 2G and 2H, the wall mounted electrical element is a home automation touch screen controller 2, having multiple functions (e.g., HVAC controls, lights controls, etc.). Out of those, the user most frequently uses two functionalities: all lights on/off and AC on/off. The user programs the housing 40 to initiate toggle all lights on/off with a single tap on door 42, toggle AC on/off with double tap, and open door 42 with a triple tap. Only when the less frequent functionalities are needed, the user will triple tap on the door 42, to expose the touch screen controller. Consequently, this will be saving the user time and effort using the most frequent functionalities on the touch screen controller 2, while keeping it concealed for esthetic reasons.

### EXAMPLE 4

This example refers to a case when two different electrical elements, such as electrical outlet 14 (FIGS. 2A and 2B) and double light switch 44 (FIGS. 2C and 2D), are installed one next to another (in separate housings). In this example, both separate housings contain a proximity sensor (such as sensor 218 of FIG. 1B), a touch sensor (such as sensor 21 of FIG. 1A) and a LED light (such as LED light 26 of FIG. 1A). When closed, both housings look the same (as seen in FIGS. 2B and 2D).

In this example, the user would like to use one of the light switches 44. In order to identify which housing contains the light switches 44, waving the hand in front of them will cause the proximity sensor of both separate housings to initiate their corresponding LED light each in different colors, thereby allowing the user to distinguish between these two closed housings. For example, the LED of electrical outlet 14 will emit white light, while the LED of the light switch 44 will emit blue light. Therefore, the type and location of the electrical element is now easily identified by color. A touch on door 22 (of FIG. 2D) will be detected by the touch sensor of that housing, which will cause the door to open, allowing the person to use the revealed switch. After a pre-defined time (e.g., 50 seconds), door 22 will close automatically.

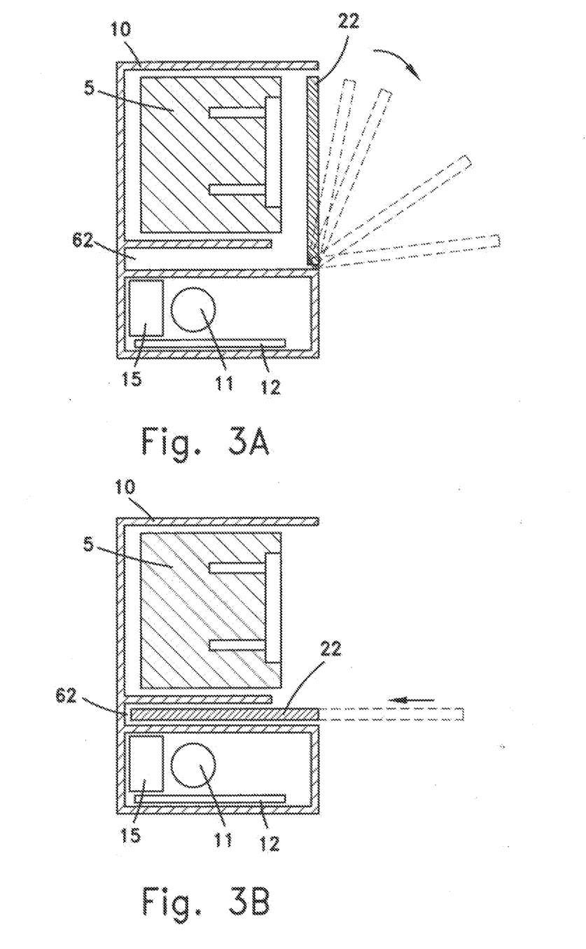

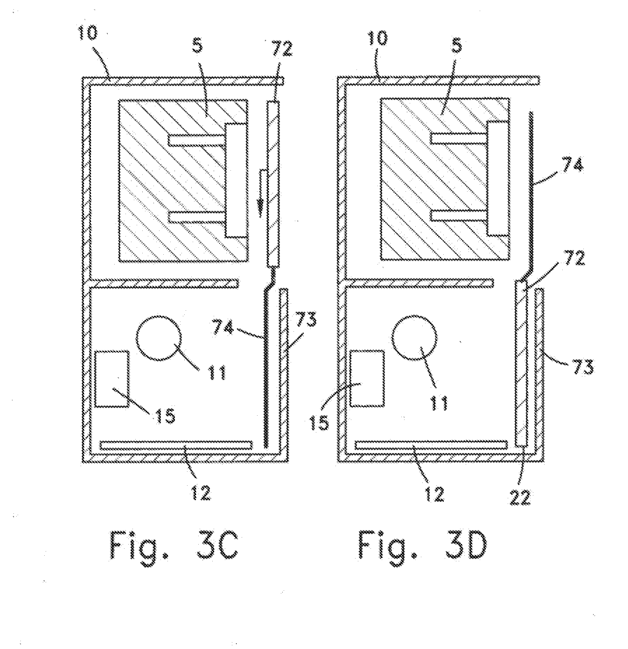

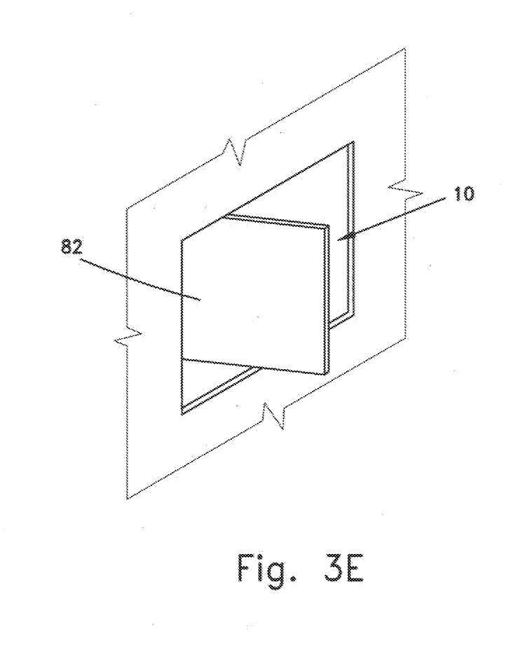

FIGS. 3A to 3F schematically illustrate different techniques which can be used to open/close door 22. Of course, door 22 can be opened and closed using further techniques, as-known to a person skilled in the art.

According to FIGS. 3A and 3B, housing 10 is provided with a door 22 which opens upwards and then inwards, into a niche 62. For example, door 22 can be physically connected to housing 10 via a suitable hinge mechanism. In order to automatically operate door 22, such a mechanism may mechanically be connected to a moving belt or gearwheel (not shown), which are in turn rotated or actuated by the electric motor 11, as known to a person skilled in the art.

According to FIGS. 3C and 3D, housing 10 is provided with a horizontally sliding door 72. When opened, door 72 slides to the side below a cover as indicated by numeral 73. For example, in such embodiment, door 72 can he physically connected to housing 10 via a suitable rail 74. In order to automatically operate door 72, motor 11 actuates a mechanism that allows door 72 to slide from one place to another along the rail 74 (i.e., between an open and closed, position as shown in FIGS. 3D and 3C respectively).

According to FIG. 3E, housing 10 is provided with a rotating door 82, For example, door 82 can be physically connected to housing 10 via upper and lower hinges (not shown), in order to automatically operate door 82, at least one of the hinges (e.g., the lower one) is mechanically connected to the electric motor 11. (FIG. 1A).

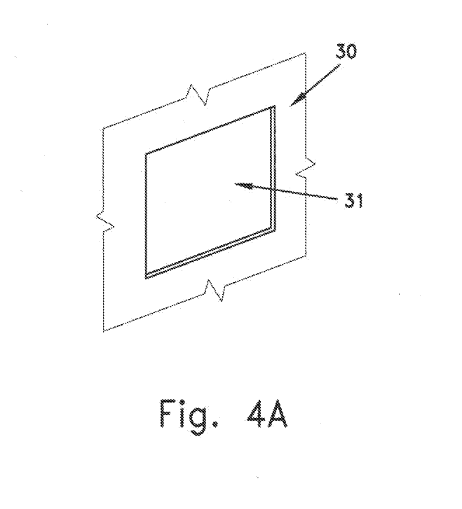

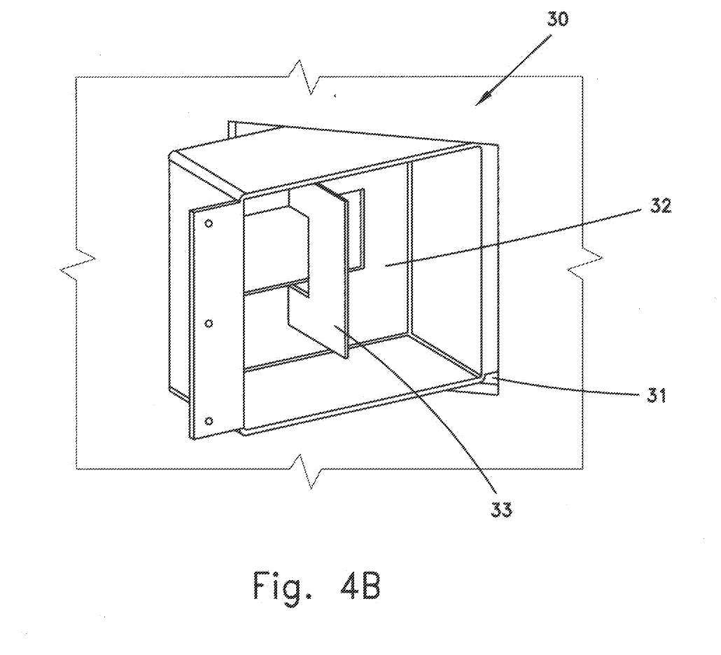

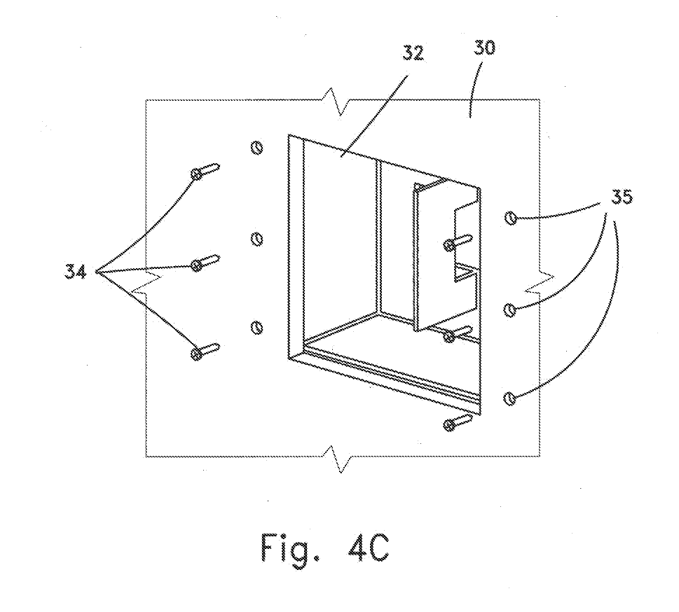

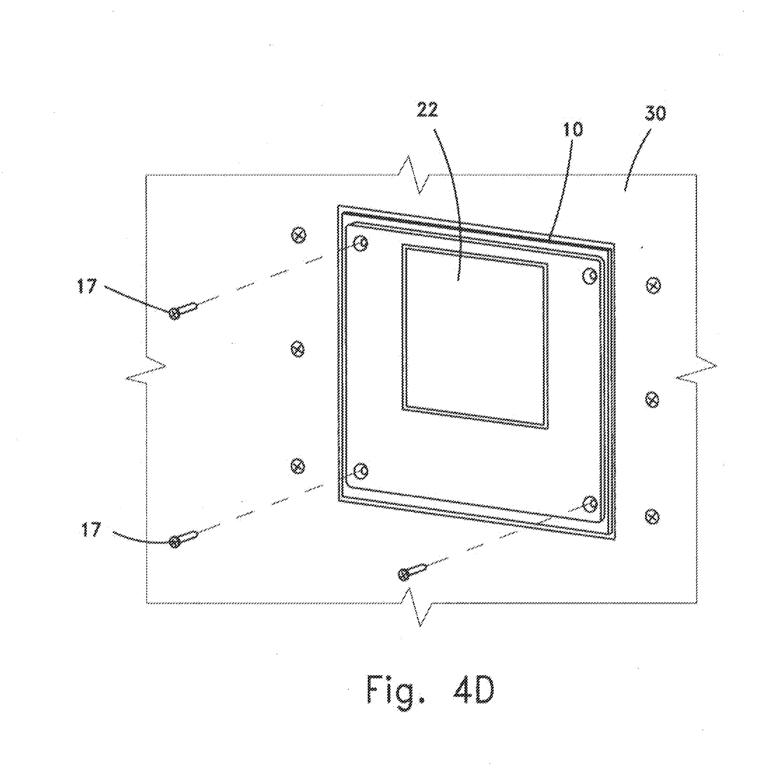

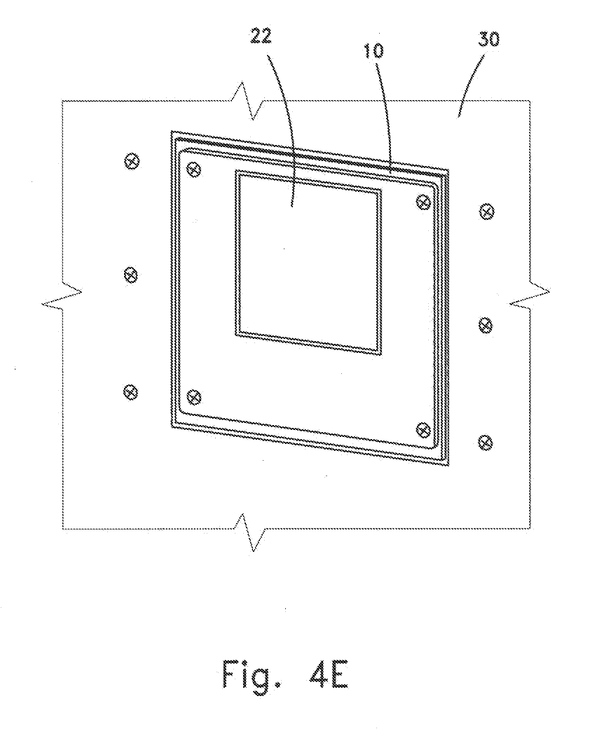

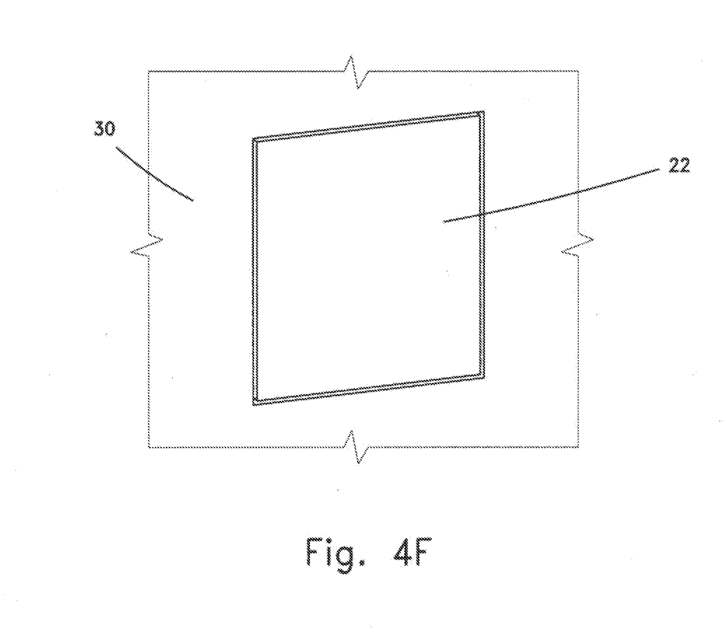

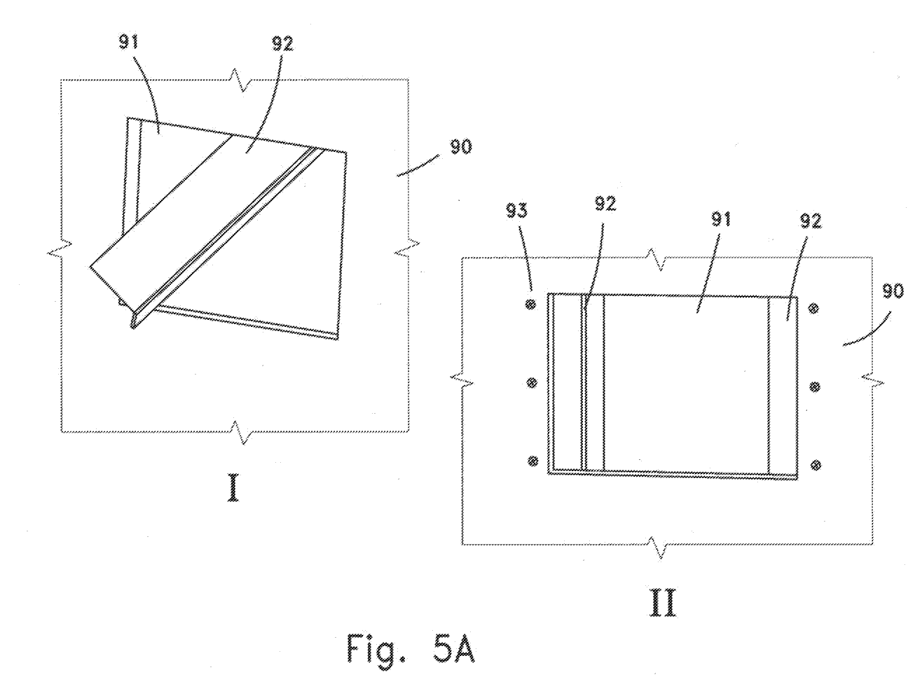

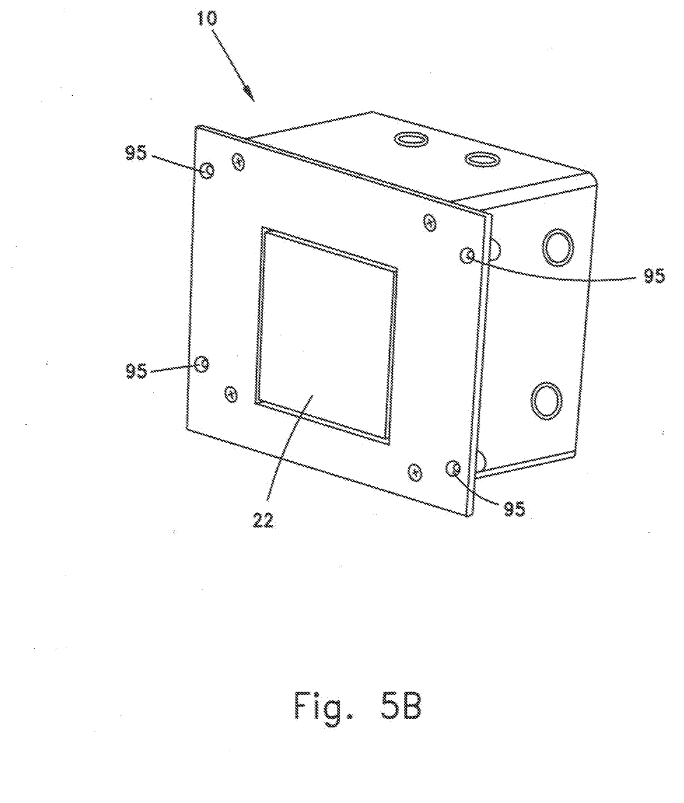

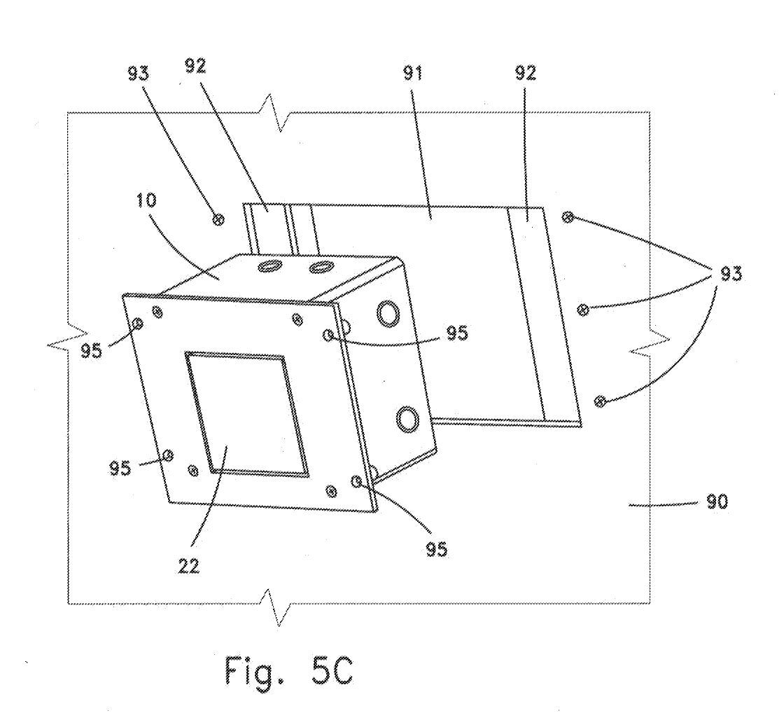

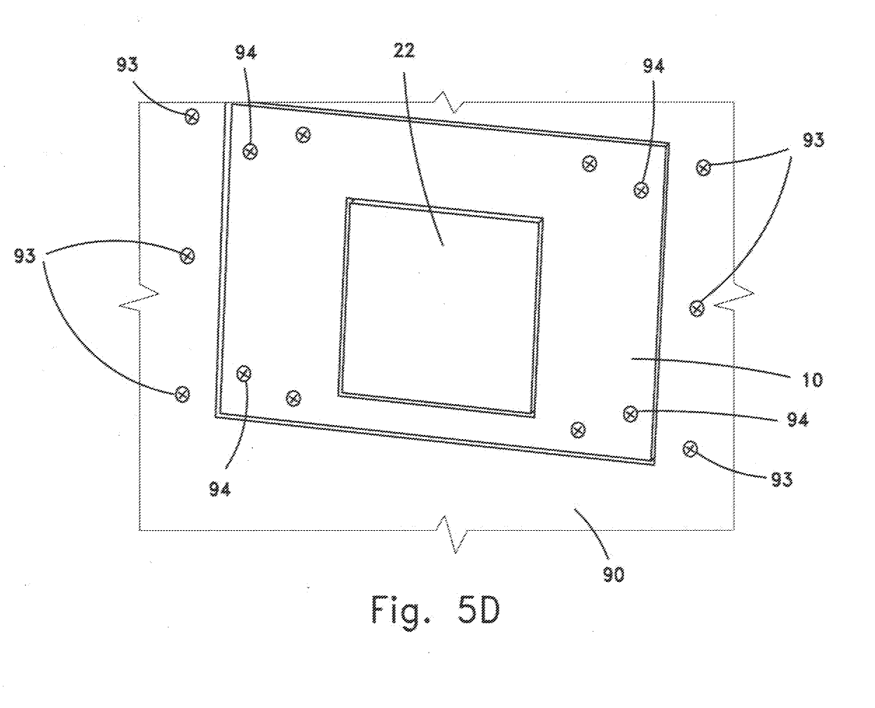

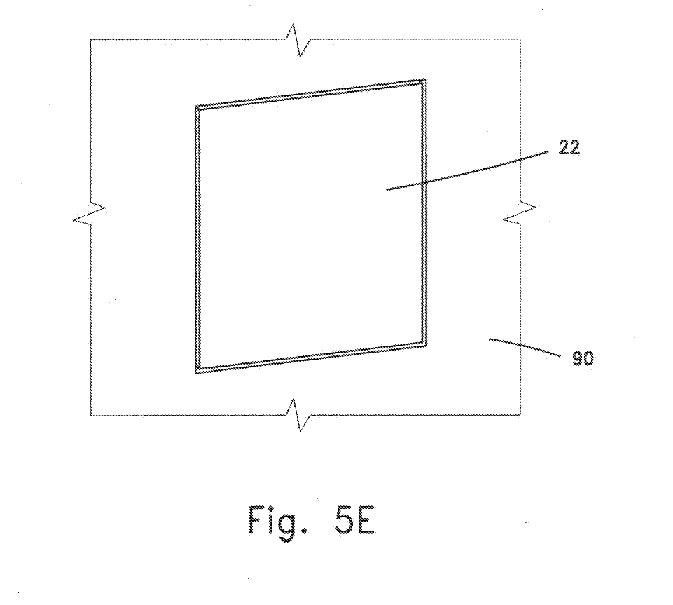

Set of FIGS. 4 and 5 schematically illustrates installation methods for attaching the housing 10 to a wall, according to some embodiments of the present invention.

FIGS. 4A to 4E illustrate a basic installation for attaching housing 10 to a wall 30 using a basic installation box 32. For installation comfort purposes, basic installation box 32 can he provided with an optional handle 33. Handle 38 can be used to hold, basic installation box 32 during the installation of box 32 to a wall. After the installation of box 32 to the wall, the handle 33 may he broken or folded. According to this example, in order to mount housing 10 in a flush manner on wall 30, the following steps can be performed:
creating an opening in wall 30, such as opening 31;
sliding the basic installation box 32 through opening 31, either by holding handle 33 (if it exists) or the body of box 32;
positioning the basic installation box 32 in the desired place;
attaching the bask installation box 82 to wall 30 with suitable screws through corresponding holes, such as screws 34 and holes 35;
threading or inserting the wiring through a suitable opening in box 32 (not shown);
attaching housing 10 to the basic installation box 32 and regulating the housing 10 to a perfect flush position with suitable screws 17;
electrically connecting the wiring to receptacles in the housing 10 and the electrical element (not shown); and
applying the final finish of wall 30 to approximate or relatively match the wall color and texture (see FIG. 4F).

FIGS. 5A to 5E schematically illustrate another basic installation for attaching housing 10 to a wall 90 by using wall profiles 92 or other suitable brackets through opening 91. Housing 10 can be mounted or assembled in wall 90 via a pair of profiles 92 by attaching housing 10 to the profiles 92 (e.g., with suitable screws) and regulating the housing 10 to a perfect flush position.

FIG. 5A schematically illustrates in two steps (indicated by indicia I and II) the insertion, of the wail profiles 92 through opening 91 (step I) and their attachment to wall 90 using screws 93 (step II). FIG. 5B schematically illustrates a perspective view of housing 10, according to an embodiment of the present invention. FIG. 5C schematically illustrates housing 10 prior to its installation m wall 90 and FIG. 5D schematically illustrates housing 10 after its installation in wall 90. For example, housing 10 can be attached to wall 90 via the wall profiles 92, by using screws 94 through the corresponding screw holes 95. FIG. 5E schematically illustrates housing 10 installed in wall 90 in a flush manner and after the painting of wall 90, which provides an esthetic view to the wall surface. Thereby, only a contour around door 22 is seen on the surface of wall 90 after the installation of housing 10 is completed.

The installation of such smart housing can he implemented in various other ways and with different construction elements, in plaster walls, concrete walls, brick walls, wood wails or other types of walls mutatis mutandis.

While some embodiments of the invention have been described by way of illustration, it will be apparent that the invention can be earned into practice with many modifications, variations and adaptations, and with the use of numerous equivalents or alternative solutions that are within the scope of persons skilled in the art, without departing from the spirit of the invention or exceeding the scope of the claims.

1-20. (canceled)

21. A smart automatic and autonomous housing for at least one wall mounted electrical element which minimizes the user's effort and maximizes the time said electrical element is concealed, wherein said housing is configured to be installed in a flush manner in a wall, comprising:
a. a door for allowing on demand access to said wall mounted electrical element, and whenever said door is completely closed—said wall mounted electrical element becomes concealed, while only a contour around said door is visible on the wall in which said housing is installed;
b. an electric motor mechanically connected to said door, for moving said door between close and open positions;
c. a control circuit, electrically connected to said motor, for performing tasks related either to the status of said electrical element without the need to open said door, or to the determination whether to automatically open said door upon the detection of a user's intention to use said electrical element or to automatically close said door after the use, wherein each of said tasks can be performed either with or without any physical contact by the user;
d. at least one sensor, electrically connected to said control circuit, for providing information to said control circuit in order to trigger said control circuit to perform said tasks, wherein said at least one sensor is positioned in said housing in such a way that said at least one sensor will be able to detect the intention of a user to use said electrical element and/or to detect whenever said electrical element is in use; and
e. a power source for powering said housing.

22. A housing according to claim 21, in which the sensors are selected from the group consisting of: proximity, touch, sound, light, movement, micro-switch, or combination thereof.

23. A housing according to claim 21, in which the control circuit comprises a memory module for storing pre-defined information related to the operation of the door and/or information related to the operating or status of at least one of the electrical elements.

24. A housing according to claim 23, in which the pre-defined information represents a combination of one or more gestures detected by at least one sensor.

25. A housing according to claim 24, in which the control circuit is further used in combination with at least one of the sensors for obtaining a correct sequence which represents the stored pre-defined information, wherein the correct sequence is a time based sequence and/or gesture based sequence.

26. A housing according to claim 24, in which the pre-defined information is programmable/pre-programmed.

27. A housing according to claim 21, further comprising one or more light sources, wherein, whenever the door is in a closed position, said light sources emit one or more light colors, either automatically and/or according to one or more gestures.

28. A housing according to claim 27, in which at least one of the light sources is used to provide visual information regarding the status of the electrical element, whenever said electrical element is electrically connected to the control circuit.

29. A housing according to claim 27, in which at least one of the light sources is used to provide visual information regarding the type and/or location of the concealed electrical element.

30. A housing according to claim 21, in which the electrical element(s) are attached to said housing via corresponding socket(s), wherein said sockets can be used to detach or replace said electrical element(s).

31. A housing according to claim 21, in which whenever the door is completely open, it is fully contained in said housing in such a way that said door is minimally visible.

32. A housing according to claim 21, in which the control circuit instructs the door to remain open whenever at least one of the sensors detects that the electrical element(s) is in use.

33. A housing according to claim 21, in which the control circuit instructs the door to move into a closed position whenever the electrical element(s) is not in use.

34. A housing according to claim 21, in which the control circuit is electrically connected to at least one of the electrical elements in order to operate said electrical element(s) and/or to receive information related to said electrical element(s).

35. A housing according to claim 34, in which the control circuit operates the electrical element whenever at least one of the sensors detects the intention of a user to use the electrical element(s).

36. A method for allowing to operate, automatically and autonomously, at least one wall mounted electrical element which is located within a smart housing, while said electrical element is substantially concealed behind a door of said housing, said method comprising the steps of:
a. providing a control circuit for performing tasks related to the status of said electrical element whenever said door is in a closed position and said electrical element is concealed, wherein said control circuit is located within said smart housing; and
b. providing at least one sensor, electrically connected to said control circuit, for providing information to said control circuit in order to trigger said control circuit to perform said tasks, wherein said sensor is positioned in said housing in such a way that said sensor is used at least for detecting the intention of a user to use said electrical element without the need to open said door or without any physical contact with said electrical element.

37. A method according to claim 36, wherein the provided information is selected from the group consisting of: time interval(s), one or more gestures, sensor output data, or any combinations thereof.

38. A method according to claim 36, further comprising operating the electrical element by directly using one or more pre-defined definitions stored within the control circuit, thereby eliminating the need to open the door.

39. A method according to claim 36, further comprising providing visual information regarding the type, the location and/or the status of the electrical element by using one or more lighting sources.
